(19) United States
(12) Patent Application Publication
(10) Pub. No.: US 2025/0122048 A1
(43) Pub. Date: Apr. 17, 2025

(54) ELEVATOR ELECTRONIC UNIT AND ASSOCIATED ELEVATOR SYSTEM, METHOD FOR SECURE SOFTWARE UPDATE AND METHOD FOR A DOWNSTREAM SECURITY CHECK

(71) Applicant: Ziehl-Abegg SE, Künzelsau (DE)

(72) Inventors: Roland Hoppenstedt, Zweiflingen (DE); Martin DIEFFENBACH, Langenbrettach (DE); Mathias SPANNAGEL, Ingersheim (DE)

(73) Assignee: Ziehl-Abegg SE, Künzelsau (DE)

(21) Appl. No.: 18/912,802

(22) Filed: Oct. 11, 2024

(30) Foreign Application Priority Data
Oct. 13, 2023 (EP) 23203544.4

(51) Int. Cl. B66B 1/30; B66B 1/34; B66B 5/00

(52) U.S. Cl. CPC B66B 1/308; B66B 1/3446; B66B 5/0031

(57) ABSTRACT

An intelligent elevator electronic unit having a central processor which both implements a motor control including time-critical motor control signals and performs basic functions of elevator operation, such as responding to external calls, specifying a travel curve or evaluating a safety circuit of the elevator system in which the elevator electronic unit is used to control an elevator motor. The elevator electronic unit also includes the power output stage required for operating the elevator motor and can also include one or more additional processors, with which the functionality of the elevator electronic unit is expandable in a modular manner. With this architecture, it is possible in particular to safely perform software updates of the central processor and/or an additional processor, to perform a downstream security check of such a software update or, for example, to autonomously optimize the operation of the elevator system with the aid of the central processor.

### CROSS-REFERENCE TO RELATED APPLICATIONS

This application claims priority to European Patent Application No. 23203544.4, filed Oct. 13, 2023, which is incorporated herein by reference as if fully set forth.

### TECHNICAL FIELD

The invention relates to an elevator electronic unit which is provided and set up to control an elevator operation, i.e. a travel operation of an elevator system. For this purpose, the elevator electronic unit can comprise the following components, which are preferably accommodated in a common housing: a power output stage, which can supply an elevator motor of the elevator system with an (in particular three-phase) AC output voltage; and (at least) one processor. In addition, the invention also relates to an elevator system comprising such an elevator electronic unit.

Furthermore, the invention relates to a method for safely updating such an elevator electronic unit and/or an elevator system as well as a further method for the downstream and autonomous security check of an elevator electronic unit and/or an elevator system, wherein downstream can be understood here as meaning that the security check is carried out autonomously after a software update has been carried out by the elevator electronic unit.

### BACKGROUND

Frequency inverters with power output stages for operating elevator motors with or without gears have been used in elevator systems for a long time and are often implemented in a 1-processor solution, i.e. with a processor that can receive complex digital control commands and translate them into corresponding, in particular analog, control signals to control the power output stage. Some available frequency inverters are specially adapted for use in an elevator system, both in terms of their interfaces and their respective designs.

Typically, however, elevator control functions are implemented by several separate electronic units or solved by them. Tasks of such control electronics or electronic elevator control devices, which are often designed separately from the frequency inverter, can be, for example: querying a safety circuit, detecting a door zone, evaluating interior and exterior calls, determining the cabin position, reacting to control commands from the cabin roof or from the pit or from the return control, as well as controlling special operating modes such as a fire department elevator. In recent years, communication with a remote control or remote monitoring system or a building control center or, for example, operation with a cloud database have also been added.

One problem with these familiar approaches is that elevator safety functions, time-critical motor control operations and cybersecurity functions (i.e., functions that affect the security of the elevator system against attacks from the network) are distributed across completely different electronics. As a result, the complexity of such elevator systems increases more and more, and with it the cost of installation, maintenance and the constant need to update the entire system through software updates, for example to provide new functions or adapt existing functions.

Combinations of an electronic elevator control device and a motor frequency converter, which are combined as a single structural unit, are now also known. However, such previously known elevator electronic units are usually surrounded by numerous additional devices. As a result, the installation and the effort required for safe operation of the respective elevator system, which may be monitored remotely, are still very high.

### SUMMARY

Against this background, the invention has set itself the object of providing an electronic elevator control device which can be designed as a compact elevator electronic unit whose components can be accommodated in a common housing and which helps to overcome the aforementioned disadvantages.

In order to solve the object, an elevator electronic unit having one or more of the features disclosed herein is provided. In particular, in order to solve the object in an elevator electronic unit of the type mentioned at the beginning, it is thus proposed that the processor is designed as a central processor and is consequently set up to directly control the power output stage by means of motor control signals as part of a motor control system. This enables the central processor to control and regulate the elevator motor via the power output stage. In particular, this enables the central processor to preset the elevator operation. Furthermore, the central processor is designed and set up to perform basic functions of elevator operation, namely responding to external, in particular digital, calls from external transmitters by generating and outputting the corresponding motor control signals based on a respective travel curve for elevator operation.

By outputting the motor control signals, the central processor can directly control the power output stage and thus in particular move an elevator car of the elevator system to a specific elevator stop (=stop position of the elevator car), i.e. move the elevator car specifically to such an elevator stop (the elevator stop corresponds to the external call to which the central processor responds).

A travel curve can be understood as a temporal profile of the speed of the elevator car, wherein the profile indicates the course/the temporal change of the speed of the elevator car. Such a profile can include acceleration and deceleration ramps but also areas, in which a constant travel speed is achieved, or for example areas of very low travel speed, such as when correcting the car position at the end of a deceleration process, i.e. shortly before reaching a final stopping position. The central processor can calculate the travel curve section by section (i.e., for example, only specify the respective interpolation points of the travel curve bit by bit) and derive corresponding updated motor control signals from the travel curve at regular intervals of 5 ms, for example. The actual travel curve traveled by the elevator car can also be recorded by sensors and documented by the central processor, for example in the form of automatically generated log files. The travel curve can, for example, also take into account certain conditions at the end points of the elevator journey, such as a shortened shaft head at the upper end or the positioning of a folding apron at the lower end. All such points can be taken into account by the central processor when specifying the travel curve in order to specify a suitable speed profile.

With previous solutions on the other hand, the procedure is that an external elevator controller specifies the travel curve and typically generates a digital control command at regular intervals, which is transmitted to a frequency inverter, e.g. by means of CANopen communication. In the meantime, however, the frequency inverter often controls the motor itself. The frequency inverter has a separate processor/a separate intelligence, which generates corresponding control signals from the digital input commands to control the power output stage of the frequency inverter and thus also fills any time gaps.

In contrast to previously known approaches, in which a processor forwards complex control commands, such as the specification of a frequency and level of the AC output voltage (which the power output stage is to output to the elevator motor), to a second instance (such as a separate processor of a frequency converter), wherein only the second instance then translates these commands into corresponding control signals, with which the power output stage can be directly controlled, the invention thus proposes that the central processor directly generates suitable control signals, such as an analog signal or a pulse width modulation (PWM) signal, and outputs them to the power output stage, preferably without any intermediate instance. The power output stage thus preferably has no intelligence itself; however, it can, for example, comprise a hardware circuit that converts an analog signal or a PWM signal transmitted by the central processor into an analog control signal for controlling the individual transistors/power switches of an inverter circuit of the power output stage.

The motor control signals can thus be output by the central processor as analog signals and/or in the form of at least one PWM signal. By means of such motor control signals, the central processor can thus control individual power switches of the power output stage (either directly or indirectly, for example mediated via the aforementioned hardware circuit). This allows the central processor to adjust the AC output voltage accordingly so that a desired speed and/or torque of the elevator motor is obtained.

In other words, the central processor can thus realize a frequency converter together with the power output stage.

For the purpose of executing the elevator operation, the central processor can also preferably be set up to specify the respective travel curve (itself), taking into account a (respective) received external call and the evaluation of at least one piece of information regarding a current position of an elevator car of the elevator system. In this case, the central processor generates the necessary motor control signals automatically on the basis of the travel curve determined by it.

The central processor can, for example, query information that allows conclusions to be drawn about the current cabin position itself, for example by directly or indirectly reading out a sensor in the elevator system. In particular, this can therefore be reliably determined information regarding the current position of the elevator car within the elevator shaft.

However, the central processor can also obtain the information from an instance of the elevator system, for example, which continuously creates and updates a virtual image of the elevator system. Such an instance can be realized in particular in the form of a so-called shaft copying system. Such a virtual image/shaft copying system can be implemented on the basis of sensors, in particular magnetic sensors in the shaft, and/or relative encoder systems and/or an absolute encoder system of the elevator system. In this case, the information regarding the current position of the elevator car will correspond more to an estimate of the current car position.

In particular, the central processor can evaluate at least one safety circuit of the elevator system in order to obtain the information regarding the current car position. This is because such a safety circuit can provide relevant “safety-related information” regarding the car position. The safety circuit can be an element in a complex safety chain that ensures safe operation of the elevator system. The elevator operation can be designed in such a way that the elevator car can only be moved if the safety chain as a whole is in a permissible state for operation. Accordingly, the central processor can be set up to query a current state of the safety chain in order to take this state into account when specifying the travel curve.

The aforementioned safety chain of the elevator system can, for example, be implemented as a serial circuit of several safety elements (“Door closed?”, “Ropes taut?”, “Speed OK?”, etc.). Each element (which can be realized with a respective safety circuit) must have a certain state so that the safety chain as a whole is in the permissible state in which safe movement of the elevator car is possible/enabled. Such a safety chain can, for example, monitor the correct closing and opening of the doors of the vehicle cabin and only release the opening of the doors when the vehicle cabin is in a safe state. In addition, the safety chain can be designed in such a way that an interruption in the safety chain stops the elevator system from moving. The safety chain is therefore preferably higher-level than the central processor, i.e. the central processor can only operate the elevator as long as the safety chain is not interrupted.

However, the central processor can also be set up to bypass a specific element in the safety chain if certain boundary conditions are met. For example, if the elevator is to travel to a stopping position with “early opening doors”, the central processor can detect the elevator car entering a door zone, for example by reading out zone magnets that are arranged in the door zone in the elevator shaft. If the central processor detects the elevator car entering a (predefined) door zone, the central processor can specifically bypass an element in the safety chain (e.g. “door closed”) (so-called “door bypass”) and thus enable the doors to open before the elevator car has reached the final stop position (=“early door opening”). The central processor can therefore be set up to control a/the safety chain of the elevator system depending on at least one sensor signal received (for example: “elevator car within door zone”), which ensures safe operation of the elevator.

As the central processor thus receives and processes the typically digital external calls and can also communicate with other devices in the elevator system, for example to determine the current car position, the central processor combines digital communication within the elevator system with the generation of (often analog) motor control signals in one processor unit. This fusion of the digital and analog worlds in the central processor considerably reduces complexity and thus simplifies maintenance and updating of the overall system.

The central processor can, for example, be implemented in the form of a microcomputer or a microprocessor and/or on a mainboard of the electronic unit. The central processor must have sufficient performance, in particular a sufficient processor speed, to be able to execute the necessary time-critical motor control functions.

Furthermore, the central processor can have an analog signal output (for generating an analog motor control signal) and/or a PWM unit (for generating a PWM motor control signal) that is directly connected to the power output stage (in order to directly control the power output stage with the corresponding motor control signal). This allows direct motor control by the central processor to be implemented. In particular, the central processor can therefore be set up to perform a digital-to-analog conversion in order to generate analog motor control signals from digital data/commands (e.g. from the driving curve), which can be used to directly control the power output stage.

The design according to the invention therefore makes it possible to use the central processor to specify the travel mode of the elevator car and to control and regulate the elevator motor at the same time. The central processor is equipped with such a high operational speed that it can take over time-critical motor control functions.

Communication between the central processor and the power output stage can also be bidirectional, for example so that the power output stage can send a fault message to the central processor. The central processor can also be set up to record sensor data from the elevator motor (such as the current angular position of the rotor of the elevator motor). When generating the motor control signals, the central processor can take such sensory data and/or fault messages into account.

The elevator control architecture according to the invention may thus provide that the central processor is arranged: (i) to respond to incoming external calls by generating and outputting corresponding motor control signals; thus (ii) to evaluate/consider at least one piece of information regarding the current car position (=position of the elevator car), in particular evaluating/reading out a safety circuit (preferably continuously) for this purpose; and (iii) to preset/calculate a respective travel curve on the basis of a (momentarily) received external call and on the basis of at least one piece of information relating to the current car position, in particular on the basis of an evaluation of at least one safety circuit;

It may also be provided, for example, that the central processor is set up for the purpose of:
(iv) effecting a door control (door opening & door closing), for example by directly or indirectly controlling a door drive of the elevator car (this door control may also include the execution of a so-called “door bypass” by the central processor, by which the central processor bypasses an element of a safety chain); and/or of (v) monitoring a momentary state of a safety chain of the elevator system, preferably continuously.

The elevator system, in which the elevator electronic unit (which can be understood as an electronic elevator control device) is used, can for example (in a manner known per se) have an elevator car, carrying means, optionally a counterweight, as well as a drive unit (e.g. with traction sheave and) with elevator motor (either with or without gearbox). The elevator electronic unit can be designed as a compact structural unit; it can also take over the control and regulation of the drive unit, for example by controlling a motor power output stage (in particular as part of the aforementioned power output stage) of the drive unit, as already explained in detail above.

Particularly safety-relevant functions of the elevator system, especially individual elements in the aforementioned safety chain, can be implemented by means of a (respective) hardware circuit.

In order to be able to perform all important control and regulation functions, the central processor can have a serial interface as well as digital input and output ports, and also relay outputs in order to be able to output control currents for controlling relays. The central processor can also include an error memory, in which error messages that occur during operation of the elevator system can be documented, as well as a memory for recording statistical data, such as the trips made, in particular the travel curves (which can be documented/logged accordingly by the central processor=recorder function), and/or other operating parameters that can be recorded by sensors during operation of the elevator system.

The elevator electronic unit can also have safety circuits, in particular in the form of non-changeable hardware circuits, which the central processor can access (send and/or receive). The respective safety circuit can in turn be connected to external field devices, such as a position sensor or other sensor or actuator.

All of the central functions described above can be executed by the central processor without the need for (error-prone) communication with another processor. This architecture of the elevator electronic unit according to the invention has significant advantages in terms of safety in elevator operation, but also in terms of simplifying maintenance and servicing and in terms of the adaptability of the elevator electronic unit and thus of the elevator system controlled by it.

A housing in which the elevator electronic unit is accommodated can be characterized in that, inter alia, a central current and/or voltage supply is provided on the housing, via which at least one internal power supply unit of the elevator electronic unit can be supplied with electrical voltage. The at least one internal power supply unit can provide a respective suitable electrical operating voltage for operating components of the elevator electronic unit, for example to provide a specific DC voltage for the central processor and/or for one of the additional processors. Under certain circumstances, there may also be different internal DC voltage levels, since, for example, certain sensors that are supplied by the elevator electronic unit may require different voltage levels than the central processor used.

The electronic unit can also be further developed as follows:

It may be provided that the central processor is set up to implement motor control of the elevator motor, which comprises time-critical operations that must be executed in less than 1 ms. Furthermore, the central processor can be set up to implement a travel operation control of the elevator system. This travel operation control can comprise less time-critical operations, which can be executed in more than 1 ms, and/or non-time-critical operations, which must be executed within 10 ms. The central processor is preferably set up to execute the motor control function and the drive mode control function simultaneously. For this purpose, however, it is preferable if the central processor is set up to process the motor control, i.e. in particular the time-critical operations mentioned, with priority over the travel operation control, i.e. in particular with priority over the non-time-critical operations mentioned. Processing can take place sequentially and/or by means of a time-division multiplex method. The central processor can also be set up in such a way that it can interrupt operations of the travel operation control, in particular those that are not time-critical (if this is necessary in order to execute a time-critical operation directly after the interruption).

The central processor can have one or more processor cores. In the case of a multi-core architecture, i.e. the use of at least two processor cores in the central processor, one of the cores can, for example, be set up to execute time-critical engine control operations and another core can be set up to execute the drive mode control/non-time-critical operations. Furthermore, the central processor can also be designed in such a way that, for example, one of the at least two processor cores pauses at least temporarily (i.e. temporarily does not execute any operations). In all these cases, it is preferable if at least one of the cores can execute time-critical operations in real time.

Real-time relevant signals can be understood here to mean that signals must be processed within a defined maximum response time; however, this maximum response time can be in the range of several hundred ms under certain circumstances. Real-time relevant signals can therefore include both time-critical (<1 ms) and non-time-critical (>10 ms) signals.

The central processor can, for example, have a system of intelligent interrupts so that time-critical and non-time-critical operations can be processed sequentially and/or by means of a time division multiplexing (TDM) procedure by the central processor, preferably one after the other and in order of priority. The quasi-parallel execution (when using one processor core) or actually parallel execution (on at least two processor cores) of both functions (motor control and control & monitoring of driving operation) by a single central processor is thus possible because the processor can prioritize between these two functions and thus execute the time-critical operations before the non-time-critical operations. This can be achieved, for example, by means of a corresponding “interrupt” prioritization and/or by using two processor cores. If only one processor core is used, it may be characteristic that the central processor executes both functions serially one after the other, but at such short intervals that quasi-parallel execution of both functions by one and the same central processor is possible.

For this purpose, a program for monitoring the elevator operation of the elevator system (more precisely, the operation of the elevator car) and a program for motor control can be stored in a memory of the central processor. Both of these programs can be configurable by means of digital software updates, as will be explained in more detail, i.e. these programs can be stored in an (in particular respective) overwritable (internal or external) memory.

One of the advantages of this approach is that the processor's software is easier to maintain than maintaining two separate processors. The solution is also more cost-effective because one processor can be saved, and there are no more error-prone contacts or cables because communication between the two processors is eliminated. In addition, the update process is simplified when only one central processor is used, as is the error analysis of the overall system due to the elimination of communication between two processors, as was previously the case.

The elevator electronic unit can be used especially advantageously if it comprises at least one additional processor that is set up to perform at least one additional function. This additional function can therefore supplement the functional scope of the central processor in a modular manner. For example, it may be provided that the at least one additional processor is plugged into a mainboard on which the central processor is implemented. This makes it very easy to add an additional function in a modular way by plugging in the additional processor, i.e. in particular to retrofit it.

The at least one additional processor can communicate with the central processor, for example by means of a serial interface, in particular in the form of a BUS system for data transmission. In addition or as an alternative, a so-called dual-ported RAM can also be used to enable communication/data exchange between the additional processor and the central processor. Depending on the design, such a dual-ported RAM can be written to and read by both processors in particular, so that, for example, the additional processor can read information from the dual-ported RAM that the central processor has stored there and vice versa.

The respective additional processor can therefore be regarded as a modular peripheral device of the central processor, via which the central processor receives access to additional functions and/or implements such additional functions. By means of such an additional processor, a so-called STO (Safe Torque Off) function (which ensures that an unintentional energization of the drive can be safely prevented) or, for example, a brake control/brake control function, with which a mechanical brake of the elevator system can be safely controlled and operated, can be implemented as an additional function. Such a procedure is suitable, for example, if an electromechanical brake is to be controlled by means of a PWM signal, which PWM signal can then be generated by the assigned additional processor. In this case, the actual (in particular digital) command for braking can be transferred from the central processor to the additional processor, wherein the central processor can derive from the respective travel curve at which points in time the brake should be applied or at which points in time the brake should be released. It should be noted here that such electromechanical brakes usually release when energized and engage when the power supply/PWM signal is removed. If the central processor therefore wants to apply the brake, it will instruct the additional processor to set the current supply to the brake accordingly.

Preferably, the central processor can implement an electronic braking circuit (in particular using an electrical braking resistor) with which braking energy can be dissipated electrically in a controlled manner. For this purpose, the central processor must have a controlling effect on the motor/drive unit of the elevator system, which is precisely the task of the central processor. For this purpose, the central processor can, for example, control an IGBT or another suitable power switch of a hardware circuit in order to connect an electrical braking resistor. Such an electronic braking circuit, which is implemented with the help of the central processor, can be used in particular to avoid overvoltages, for example in an intermediate circuit of the power output stage.

Central functions that can be implemented by means of the central processor can also be:
a fire department elevator mode (this operating mode of the elevator system can, for example, enable rapid movement of the elevator car for firefighters in the event of a fire and/or prevent the elevator car from stopping in the event of a fire on floors where smoke detectors have detected heavy smoke development, for the protection of firefighters);
an emergency power and/or evacuation mode (e.g. to carry out an emergency power evacuation of passengers, in particular when a gearless drive unit is used);
an emergency release function for releasing persons who are stuck in the elevator car, in particular wherein the emergency release function can include communication with an (external) remote control of the elevator system, for example from a service center; or
a group control of several elevator cars of the elevator system.

For all such central functions carried out by the central processor, the central processor can of course also make use of an additional processor, i.e. instruct the respective additional processor accordingly by means of signals and/or digital commands, for example to establish a remote connection or actually carry out the respective additional function.

If the elevator system comprises two or more cabins that are moved in two or more shafts but are electronically connected to each other to form a system, a group control system as mentioned above can, for example, determine which cabin is moved by the elevator electronic unit in order to respond to an incoming external call. In this case, two separate elevator electronic units according to the invention can also be designed in the entire elevator system, which are then electronically networked with each other and set up to coordinate the processing of incoming external calls. In other words, the central processor of an elevator electronic unit according to the invention can be set up to communicate with at least one further central processor of a further elevator electronic unit, in particular in order to process incoming external calls in a coordinated manner, namely by generating and outputting corresponding motor control signals in order to move one of at least two elevator cars of the elevator system.

Other possible additional functions that can be performed by an additional processor are
an evaluation of additional call systems, to receive further external calls;
a gateway keeper function, for example to establish electronic contact with a home control center or an external computer network/cloud;
a brake monitoring function with which the correct functioning (in particular correct release and/or correct application) of a mechanical brake, in particular a mechanical motor brake, of the elevator system can be monitored (this brake monitoring function, which the additional processor implements, can be based on the evaluation of sensor signals, in particular from microswitches and/or contact switches, and/or on an electrical current and/or voltage measurement);
a brake wear monitoring function with which wear on a mechanical brake of the elevator system can be determined or at least estimated;
a brake control function (enables the brake to be released and applied correctly at suitable points in the travel curve; for example, the additional processor can have a controlling effect on a brake operating circuit), with which such a brake can be opened/released and applied in a targeted manner. It should also be mentioned at this point that if the safety chain is interrupted, this interruption will put the respective brake into a de-energized state so that the vehicle cabin comes to a safe stop.

The respective additional function will generally not be included in the range of functions covered by the central processor. When executing the respective additional function, an additional processor can therefore execute commands in the context of the respective additional function in a decentralized manner with respect to the central processor and/or simultaneously with the central processor. It is understood that a respective additional processor can also be set up to execute/take over several such additional functions.

A further central function, which is preferably performed by the central processor, can, as mentioned, be to enable electrodynamic braking of the elevator car or recuperation of kinetic braking energy. For this purpose, the central processor can, for example, control an energy supply and recovery unit (in particular as a preliminary stage of the power output stage). This allows kinetic braking energy to be recuperated as electrical power during regenerative operation of the elevator motor and fed back into an external power grid. In particular, the control can be implemented via an additional processor. However, if this function is not to be implemented, the additional processor that is to control the regenerative unit can be omitted accordingly. The additional processor therefore adds functionality that is controlled by the central processor.

Another important additional function that can be added with the help of an additional processor can be to enable the central processor to communicate with the Internet, as the central processor should not have direct access to the Internet for security reasons. The at least one additional processor can thus serve as a gatekeeper and then provides the central processor with secure Internet access, similar to a router.

The modular retrofitting or upgrading of at least one additional processor makes it particularly easy to adapt the functionality of the elevator electronic unit to customer requirements, which significantly expands the possible uses of the elevator electronic unit. A particular advantage here is that all functions relevant to the personal safety of the elevator system can be carried out by the central processor, so that the safety test can initially be limited to the elevator electronic unit without additional processors. In a second step, the safety of the overall system comprising the central processor and additional processor can then be checked.

The at least one additional processor can be operated or be operable with a standardized, hardware-independent, programmable software, in particular with a standardized hardware-independent operating system such as Linux, or comprise such a software.

As a technical alternative to this, however, it is also possible for the at least one additional processor to communicate with the central processor on the basis of interrupts, in particular bidirectionally. In this case, the additional processor does not need its own operating system. In such a design, it is advantageous for efficient communication if the at least one additional processor is set up to trigger at least one central interrupt of the central processor in order to trigger a central interrupt service routine of the central processor assigned to this central interrupt (if required). Furthermore, it may also be provided alternatively or additionally (namely depending on the function to be performed by the additional processor) that the central processor is set up to trigger a peripheral interrupt of the at least one additional processor in order to trigger (if required) an interrupt service routine of the at least one additional processor assigned to this peripheral interrupt. The transmission of a peripheral interrupt from the central processor to the additional processor can, for example, indicate to the additional processor a specific (in particular time-controlled) event, such as a flush approach to a stop position with the car or a specific operating situation of the elevator system. In response to the peripheral interrupt, the additional processor can thus trigger an associated suitable action, whereby, for example, suitable comfort functions (visualizations and/or the playback of an audio file etc. when a certain stopping position is reached) can be implemented or a momentary special operation of the elevator system can be made known to persons.

Conversely, the additional interrupts of the central processor triggered by the additional processor can initiate certain actions of the central processor. Here, however, it is preferable if the central processor is set up in such a way that such central interrupts acting on the central processor from outside/from an additional processor cannot interrupt time-critical operations, in particular of the motor control, which the central processor is currently executing. In other words, these external central interrupts can/should be deprioritized compared to internal interrupts generated by the central processor itself.

In order to facilitate the customization of an additional processor for the customer, a table can be provided, for example, which lists which peripheral interrupts correspond to which events. On the basis of such a table, the customer can then adapt the respective peripheral interrupt routine according to his wishes in order to implement a certain customer-specific function with the additional processor. However, it is not necessary to adapt the central processor for this, which shows the advantage of this concept.

In both cases, i.e. the use of a separate operating system in the additional processor or communication via interrupts, an “open platform for third parties” can be created, which can easily implement their own control functions and/or operating options and/or visualizations (e.g. on a display unit in the elevator car) or voice announcements or other additional functions, in particular comfort functions, with the help of an additional processor. If, for example, the visualization of an operating interface of the elevator system is to be adapted to customer requirements, it is sufficient to make the corresponding changes in the additional processor. For this purpose, the elevator electronic unit can also have an adaptation interface via which the respective additional processor can be reprogrammed (in particular by a customer on site). In all these cases, the central processor can transmit unchanged commands to the additional processor to display certain information; however, the additional processor will then visualize this information on the display unit and/or convert it into a corresponding function/output according to the customer's wishes. For this purpose, for example, an operating interface of the elevator system does not necessarily have to communicate bidirectionally with the central processor, but bidirectional communication between the central processor and the additional processor, in particular by means of interrupts, is usually sufficient.

However, as an alternative to this concept, depending on the application, the additional processor (such as the central processor) can also be operated using hardware-dependent, in particular proprietary, software. Although this can have disadvantages for third parties, it can lead to greater security for the overall system.

The at least one additional processor can also transmit information to the central processor; however, it is preferable if the respective additional processor cannot access the central processor in a controlling manner. This is because it is possible to prevent safety-relevant operations that the central processor must perform safely from being disrupted by the additional processor. Conversely, however, it may be possible for the central processor to have controlling access to the at least one additional processor. For example, the central processor can thus adapt a sequence of command execution of the respective additional processor and/or put the respective additional processor into a sleep or hibernation state or wake it up from such a state.

The elevator electronic unit can also include other components: For example, an electronic call interface via which the central processor can receive and evaluate the external calls. Furthermore, at least one electronic safety interface, via which the central processor can receive and evaluate signals from the at least one safety circuit. Depending on the design, the central processor can also use such an interface to act in a controlling manner on the safety circuit, for example to enable the safety circuit to be bypassed (as already explained above with reference to the safety chain). And finally, at least one electronic internal communication interface via which the central processor can communicate with the at least one additional processor, in particular mediated via a further additional processor and/or bidirectionally. It is preferable here if the safety interface and/or the internal communication interface are each realized by means of a BUS system.

The central processor can thus receive external travel commands via the call interface and translate these into corresponding control commands, actuator control commands (e.g. to open the elevator car door) and/or motor control signals (to control the power output stage).

Via the safety interface, the central processor can query safety-relevant information from external field devices, in particular sensors and actuators of the elevator system, and/or transmit actuator control commands to such a field device and/or read out a safety circuit and/or act on the aforementioned safety chain, in particular bypass an element in the safety chain.

Via the internal communication interface, the central processor can communicate with the at least one additional processor, receive central software updates and/or release peripheral software updates, as will be explained in more detail.

A bus is defined here as a system for data transmission between several subscribers via a common transmission path: If a momentary data transmission takes place between two participants, the other participants must remain silent at the same time, otherwise they would interfere. The time of the speaking authorization is distributed according to a (time or signal) scheme known to all participants. Listening, on the other hand, is not restricted.

A preferred design provides that the central processor is set up to collect and document operating parameters during operation of the elevator system, in particular during automated test drives with the elevator car. Such operating parameters can be, for example:
current consumption of components of the elevator system, in particular a current consumption of the drive unit and/or a door drive;
measured harmonics on current and/or voltage signals, in particular of rotary encoder signals;
temperatures or temperature curves over time, in particular within the elevator electronic unit and/or in the power output stage and/or within the elevator motor;
slippage of suspension means such as ropes (this can be determined from the number of revolutions of the drive unit and the car position);
error messages;
actual travel curves traveled;
sensor data from sensors of the elevator system;
states of the safety chain;
statistical data, in particular with regard to aborted elevator trips;
monitoring data on certain device parameters, e.g. to check the plausibility of the effect of a fan of the elevator electronic unit;
deviations in a current requirement/current consumption determined during defined test drives;
measured or determined holding torques and/or deceleration values of a mechanical motor brake of the elevator system, wherein such parameters can also be recorded by the central processor, in particular by autonomously executed safe test drives; or
data regarding a load status of the elevator car (from such data, the central processor can implement appropriate reactions in the event of a fault, for example a warning output within the elevator car and/or a temporary blocking of elevator operation if a permissible load is exceeded).

In particular, the central processor can have a real-time clock for the purpose of accurately documenting such data/operating parameters. To collect operating parameters, the central processor can also use one of the aforementioned additional processors, for example if the latter implements a brake monitoring function, which the central processor can then access in order to collect/document brake parameters.

The central processor can also be set up to carry out safe test drives without passengers (for example at night) to collect such operating parameters autonomously (i.e. without a human operator). For example, the central processor can thus safely measure step responses of the drive unit, in which the central processor, during such a safe test drive, specifies steps in the speed of the motor and records the step response of the drive unit. Such test drives can also be designed as test drives in order to check/measure certain wear parameters or operating parameters that are not accessible without a safety risk during normal passenger journeys.

Furthermore, the central processor can, for example, be set up to estimate and/or detect the operating temperatures of components of the elevator system, which are important for evaluating power consumption, for example. For example, the central processor can use a real-time clock to estimate the cooling of the drive unit over time. Such sensor-detected or estimated operating temperatures can then be taken into account when carrying out the test drives and recording the current consumption.

By collecting such operating parameters, the central processor can also be enabled to determine at least one wear parameter and/or an estimate of a remaining service life of at least one component of the elevator system based on collected operating parameters. In other words, the central processor can thus continuously monitor the life status of the elevator system and/or its wear and further, based on such determinations/estimates, initiate maintenance of the elevator system and/or the replacement of a component of the elevator system, for example by sending a corresponding digital message (e.g. push message via the Internet), for which the central processor can make use of an additional processor. The operating parameters and/or determined wear parameters or remaining service life stored by the central processor can of course also be retrieved externally, in particular via the Internet, wherein one of the additional processors can then forward a retrieval request received via the Internet to the central processor.

Another desirable functionality that the central processor can implement is to autonomously, i.e. independently, optimize the operation of the elevator system. For example, the central processor can use the measured current consumption of a component of the elevator system (in particular the drive unit and/or a door drive) to adapt the control of this component, in particular to enable low-wear operation or improved performance of the component. For example, safe test drives (which can be regarded as “reference runs”) can be carried out without passengers in the elevator car (i.e. in an unloaded state) within certain times, preferably at night, automatically controlled by the central processor, and the central processor can be set up to automatically optimize at least one control parameter by means of such test drives, in particular taking into account a current temperature of the power output stage and/or the elevator motor. Such control parameters can in particular be parameters of a current control and/or a speed control of the drive unit/elevator motor. The central processor can therefore adjust a current controller and/or a speed controller during optimization.

Furthermore, the central processor can use autonomous monitoring of the operation of the elevator system to detect specific behaviors of the users of the elevator system and optimize the operation of the elevator system on the basis of such monitoring. Such optimization can, for example, result in the central processor autonomously moving the elevator car to certain floors at certain times of the day.

For example, if the central processor detects an excessive (electromechanical) load on the drive unit, for example because a temperature of the power stage and/or the elevator motor exceeds an upper limit (“power stage and/or motor too hot”), a door closing time and/or a door opening time (both can be summarized under the term “door movement time”) can be extended. In this way, the central processor can intelligently provide the drive unit with longer cooling phases when the load is high (i.e. when the elevator car is still stationary because the doors close more slowly/later), without these longer cooling phases being directly visible to the user. If, on the other hand, the utilization of the drive unit decreases again, the central processor can, in response to this, for example in response to a drop in the temperature of the power output stage and/or the motor, extend the door closing time and/or the door opening time again in order to accelerate the travel operation (more precisely: the starting after entering the cabin and/or the door opening when a stop position is reached and/or a travel speed of the elevator cabin).

The central processor can also be set up to perform a security check of a peripheral software update that is obtained from an external source (e.g. a USB storage device or mediated via a network connection) in order to be able to install it on the at least one additional processor. By means of such a peripheral software update, for example, an additional function executed by the additional processor can be updated and/or adapted, in particular according to customer requirements. In the case of the aforementioned security check, it is now preferable if the peripheral software update can only be installed once it has been approved in advance by the central processor.

When checking and releasing the peripheral software update, it is preferable for the central processor to check at least one release condition. For this purpose, the central processor can make contact with an external instance, in particular via an additional processor, and/or, for example, request confirmation by an operator (e.g. by pressing a button on the electronic unit). The verification can also include a separate authentication of the peripheral software update, preferably by means of a (very secure) 2-factor authentication.

Two-factor authentication can be understood here to mean, for example, that the admissibility of updates is checked by the central processor and that confirmation is also obtained from the central processor by an operator (who then influences the electronic unit on site). One of the factors can include, for example, biometric or hardware-based identification. In this way, the permissibility of the update can be reliably checked and the additional processor can then be updated accordingly. The central processor can therefore initiate the actual update process of the additional processor. Both factors of such a 2-factor authentication can also be obtained via the Internet (preferably via an encrypted communication link), which can implement sufficient security for the release of the installation of a peripheral software update, for example.

If the central processor, as proposed by the invention, takes over all essential safety functions for operating the elevator system, it can also be ensured that safety functions cannot be adapted by updating the software of the at least one additional processor. Therefore, third parties can also safely specify or initiate such peripheral software updates. However, checking the peripheral software update can increase cybersecurity, for example, because it can limit the number of third parties who can perform or initiate peripheral software updates. According to the invention, the peripheral software updates should therefore only serve to enable the adaptation of certain (convenience) applications. If the additional processor is reprogrammed by third parties, there can therefore be no conflict with safety-relevant functions of the elevator due to the architecture of the elevator electronic unit according to the invention.

The at least one additional processor can comprise at least one additional processor that is set up to perform a security check of a central software update that is obtained, for example, from an external source (e.g. a USB storage device or mediated via a network connection). The central software update can/should be installed on the central processor in order to update it. Such a central software update can therefore be used in particular to update and/or adapt a function of the central processor that is relevant to safety for the operation of the elevator system, for example the aforementioned motor control and/or the aforementioned travel operation control. For safety reasons, it is also preferable here if the central software update can only be installed on the central processor after it has been released by the additional processor.

As with peripheral software updates, it is also preferable for such a central software update if said additional processor makes contact with an external instance, in particular mediated via another additional processor, to release this central software update and requests confirmation by an operator (e.g. by pressing a button on the elevator electronic unit). This verification/release can therefore include authentication of the central software update, preferably by means of (very secure) 2-factor authentication. Since the central software update can affect safety-relevant functions of the elevator system, as mentioned above, it is preferable if at least one of the two factors of the 2-factor authentication is not obtained via an external instance, but can only be entered by manually pressing an operating element (for example a mechanical button or a virtual button on a touch display) on the elevator system, preferably on the elevator electronic unit (for example by a service technician on site). In this way, security can be significantly improved when installing the central software update. In particular, this makes it much more difficult to install a corrupted central software update on the central processor by means of a pure cyber attack, because the control element cannot be manipulated remotely.

It is understood that the central processor can put the elevator system into a safe operating state before installing a central software update or a peripheral software update. For example, it is not possible to install a central software update if the central processor is currently running the elevator car.

In the approach presented for the secure installation of a central software update, the additional processor therefore monitors the security and permissibility of the software update that is to be installed on the central processor. It is particularly preferable if the additional processor only grants this release if at least one further release condition is fulfilled. This release condition can relate in particular to parameters that were recorded and saved during operation of the elevator system before the central software update was installed. The central processor itself or the at least one additional processor can, for example, record and store these parameters.

The central software update can, for example, be obtained securely via an additional processor that establishes contact with the Internet or another external source (router).

A release condition checked by the additional processor, as mentioned above, can be, for example, a certain minimum number of error-free trips that the elevator system has completed in a certain period of time. Another possible release condition is release by means of a separate remote connection, for example by contacting a secure server. Here, the security of the remote connection can be ensured by common technologies such as separate authentication, preferably 2-factor authentication, and/or encryption (e.g. using a VPN connection). Using such and comparable approaches, the central processor can thus be set up to carry out a security check of the central software update to be installed and/or check the permissibility of the central software update by means of an external instance (e.g. the said secure server).

The additional processor that checks the permissibility of the update of the central processor can be implemented either i) by means of hardware-independent programmable software or ii) by means of hardware-dependent, in particular proprietary, software, the design of which therefore depends on the hardware used.

The at least one additional processor or the central processor can also be set up to carry out a downstream security check, i.e. after a central software update has been installed on the central processor and/or after a peripheral software update has been installed on one of the additional processors. Such a downstream security check can further increase the security of the operation of the elevator system with regard to cybersecurity. For this purpose, it is particularly preferable if the additional processor checks the permissibility of software used by the central processor for its operation at regular intervals.

It is also possible for the elevator electronic unit to initiate safe test drives (of the elevator car) without passengers. Such test drives can be used to record operating parameters from the elevator electronic unit, which can then be taken into account in the downstream security check. In other words, the downstream security check can include a check of operating parameters collected during such safe test drives initiated by the elevator electronic unit. Such autonomous test drives are only possible in the first place because the central processor of the elevator electronic unit, by evaluating information regarding the elevator car position (and preferably also reading out at least one safety circuit) and also specifying the travel curve, can carry out such test drives safely and, above all, autonomously in the first place. For this purpose, it is preferable if the central processor is set up to check whether there are people in the elevator car by reading out at least one sensor before carrying out an autonomous test drive.

In order to further increase the safety for persons, it can also be provided that the elevator electronic unit blocks travel of the elevator system with persons as soon as the said downstream security check reveals/notices incorrect operation of the elevator system or an error in the central software update.

For example, it may be provided that the elevator electronic unit, in particular the at least one additional processor or the central processor, carries out safe test drives without passengers in the cabin, for example at night. It is already common in the prior art, for example, to carry out learning runs or test drives to test the correct functionality of the elevator brakes. The presence of passengers in the cabin can be reliably detected by measuring the weight of the cabin. During such test drives, for example, electrical currents or other sensor signals can also be recorded as operating parameters, which then allows conclusions to be drawn about the correct functioning of the elevator.

If, despite a previous security check, a faulty update is installed on the central processor which makes the operation of the elevator unsafe or leads to errors during operation, this problem can be detected by carrying out the safe test drives and the operation of the elevator with people can then be blocked accordingly by the elevator electronic unit.

In the case of malicious malware that could reach the central processor by means of an update, it would also be conceivable that the malware only becomes active after a certain period of time, so that the malicious update cannot be detected by initial test drives. In order to avoid this, however, it may be necessary to ensure that the aforementioned safe test drives without passengers are carried out automatically at regular intervals, such as daily or once a week, by the elevator electronic unit. In this way, an automated downstream security check can be continuously ensured, which can be used in particular to detect faulty updates to the central processor.

Finally, to increase energy efficiency, it may finally be provided that the power output stage of the elevator electronic unit (together with the central processor) can be designed as an active front-end (AFE) converter. For this purpose, the power output stage can in particular comprise a regulated mains rectifier, which can be realized, for example, by means of a feed-in and regenerative unit. In such a case, the central processor can be set up to control the AFE converter in such a way that kinetic braking power can be fed back into an external network electrically using the AFE converter when the elevator motor is operating in regenerative mode. In such designs, the central processor can therefore be regarded as part of the AFE converter.

In particular, the elevator system can therefore provide for electrical power that is generated in the elevator motor during generator and/or short-circuit operation to be fed back into the grid when the elevator car is braked. In other words, a braking resistor may not be required in such a case. The elevator electronic unit, or more precisely the central processor, can thus also control and regulate such electrical feedback of kinetic braking energy from the elevator system, wherein the central processor can make use of an additional processor for this purpose, i.e. can control it accordingly. The AFE frequency converter realized in this way, optionally with a regulated mains rectifier, can have active power switches on the input side, for example in the form of IGCTs (integrated gate-commutated thyristor) or IGBTs (insulated-gate bipolar transistor). Although this requires more control effort, it opens up the possibility of feeding energy back into the grid if the mass of the elevator car driven by the elevator motor (plus any counterweight) needs to be braked during travel. For this purpose, the elevator electronic unit can also include an electrical regenerative unit that takes over the function of the electrical recovery of braking energy. Designing the power output stage together with the central processor as an AFE also enables rapid switching between motor and generator operation of the elevator motor/drive unit.

If, for example, a magnetically excited synchronous motor is used as the elevator motor, it can generate a speed-dependent braking torque that arises as soon as the motor windings are electrically short-circuited. Such a short-circuit function can be controlled with the central processor, i.e. the elevator system, in particular the elevator electronic unit, can comprise an electronic short-circuit circuit for this purpose, which can be controlled via the central processor. With such a short-circuit circuit, the motor windings of the elevator motor can thus be short-circuited as required and/or the entire frequency converter can be de-energized to the outside. In this case, the central processor can use the short-circuiting not only for the purpose of recuperating braking energy, but also, for example, in the context of emergency operation, in order to be able to move the elevator car passively and safely in the lift shaft (especially when using a gearless drive unit) via the electromagnetic braking torque generated with the aid of the short-circuit. In this case, the elevator car only moves due to its own weight (and optionally an additional load) and is slowed down by the electromagnetic braking torque; however, there may be no controlled regenerative operation.

Finally, the central processor can also be set up to process time-critical and/or real-time relevant signals and/or generate time-critical and/or real-time relevant motor control commands when executing the motor control.

To solve the above-mentioned object, a method for safely updating an elevator electronic unit or an elevator system is also proposed. Here, the elevator electronic unit can be designed as described at the beginning and/or in accordance with one of the claims directed to an elevator electronic unit or as described above. The method now provides for the update to be carried out by installing a central software update on a processor, wherein this processor can in particular be the central processor of the elevator electronic unit described above. It is also provided that the security of the central software update is first checked by an additional processor, which may in particular be an additional processor of the said electronic unit, before the update is installed, and is released by this additional processor depending on the result of the check. In this case, it is preferable for the additional processor to check at least one release condition (for the purpose of release), wherein the additional processor can access an external instance such as an external secure server for this purpose. The central software update can be obtained from an external source, for example from a USB memory or via a network connection.

It is particularly advantageous if at least one release condition checked by the additional processor relates to a parameter that was recorded and stored during operation of the elevator system before the central software update was installed. As already mentioned, this can be carried out by the central processor or by the additional processor.

Finally, to further improve safety in the operation of an elevator system, a further method is proposed which enables a security check of an elevator electronic unit and/or an elevator system downstream of a software update. This method can be used in particular as a supplement or alternative to the methods described above in order to increase safety. In this second method, it is provided that the security check is triggered by the installation of a central software update on a processor of the elevator system (in particular on the central processor and/or one of the additional processors of the elevator electronic unit) and that, furthermore, the permissibility of software used by the central processor for its operation is checked at regular intervals. This security check can preferably be carried out automatically (i.e. in particular without external triggering) by the processor itself, in particular a/the central processor or by an additional processor of the elevator electronic unit.

As part of this method, it may also be provided that safe test drives are carried out with the elevator system (preferably automatically) without passengers for the purpose of the security check and that operating parameters are recorded in the process, which are taken into account in the subsequent security check. This is because such operating parameters can be used to draw conclusions about the correct functioning of the elevator system/elevator electronic unit and thus about the permissibility and safety of the central software update carried out.

### BRIEF DESCRIPTION OF THE DRAWINGS

The invention will now be described in more detail with reference to exemplary embodiments, but is not limited to these exemplary embodiments. Further designs of the invention can be obtained from the following description of a preferred exemplary embodiment in conjunction with the general description, the claims and the drawings. In the following description of various preferred embodiments of the invention, elements which correspond in their function are given corresponding reference numbers even if their design or shape differs.

The drawings show as follows:

FIG. 1 shows a schematic view of a first electronic unit according to the invention with a central processor

FIG. 2 shows a schematic view of a second electronic unit according to the invention

FIG. 3 shows a schematic view of a third electronic unit according to the invention

FIG. 4 shows a schematic view of a fourth electronic unit according to the invention

FIG. 5 shows a schematic view of a fifth electronic unit according to the invention

FIG. 6 illustrates a secure update process of an additional processor

FIG. 7 illustrates a secure update process of the central processor, wherein a software update is installed on the central processor and final

FIG. 8 shows details of the direct communication between the central processor and the power output stage of a power electronic unit according to the invention.

### DETAILED DESCRIPTION

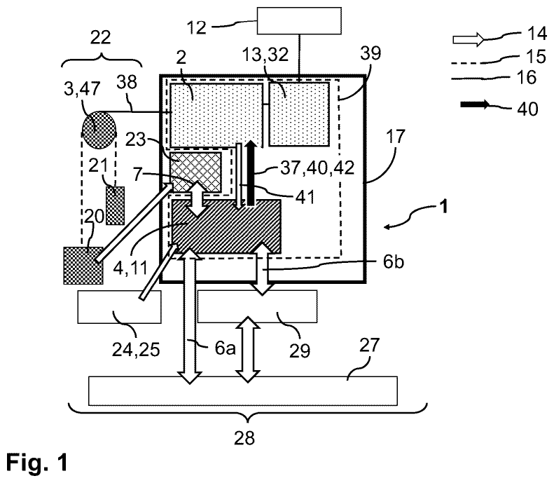

FIG. 1 shows an elevator electronic unit 1 according to the invention, which is provided and can be used to control an elevator motor 3 of a complex elevator system 28. For this purpose, the elevator electronic unit 1 comprises a processor 11 which implements a control CPU that communicates with external transmitters 27, for example an elevator user who makes an input via an operating interface. The control CPU 11, which is designed as a central processor 4, thus receives external calls and, in response, generates a suitable activation of the elevator motor 3 in order to move to a specific elevator stop with an elevator car 20 of the elevator system 28 that corresponds to the call received.

The central processor 4 thus realizes a motor frequency converter CPU, which generates motor control signals 42 and transmits them to a power output stage 2 as part of the electronic unit 1 (black block arrow). The central processor 4 and the power output stage 2 thus form a frequency converter 39 here. The power output stage 2 generates a suitable AC output voltage 38 according to the motor control signals 42 in a manner known per se in order to operate the elevator motor 3 and to move the elevator car 20, which is suspended by means of support means 15, accordingly in the elevator shaft. Here, the central processor 4 reads a shaft position sensor or other field devices 24 as required, which are relevant for the safe operation of the elevator 22. In this way, the central processor 4 can safely preset the operation of the elevator system 28.

The central processor 4 of the elevator electronic unit 1 of FIG. 1 can not only communicate directly with the power output stage 2 in order to implement a motor control 37, but can also read out a safety circuit 23 via an electronic safety interface 7, which in turn queries information from safety-relevant field devices 24 or other sensors 25. The central processor 4 thus performs basic functions of elevator operation, such as moving to a desired elevator stop, since the central processor 4 responds to incoming (i.e. external) digital calls from external transmitters 27 by generating corresponding motor control signals 42 and transmitting them directly to the power output stage 2.

In the context of a motor control 37, the central processor 4 thus directly controls the power output stage 2 by means of the motor control signals 42 and thus, mediated by the power output stage 2, controls the elevator motor 3, namely in accordance with the incoming call. For this purpose, the central processor 4 generates a respective travel curve on the basis of the incoming external call and taking into account at least one piece of information regarding a current position of the elevator car 20 and derives the corresponding motor control signals 42 from this travel curve. The central processor 4 generates the travel curve in sections, so that updated motor control signals 42 are output from the central processor 4 to the power output stage 2 at regular intervals.

As illustrated in FIG. 8, the central processor 4 can have at least one analog signal output 43 and/or at least one PWM unit 44, each of which is/are directly connected to the power output stage 2 in order to transmit analog signals and/or PWM signals 40 as motor control signals 42 directly to the power output stage 2. However, it can also be seen in FIG. 8 that the power output stage 2 can comprise a hardware circuit 45, for example in order to convert a PWM signal 40 into corresponding analog control signals for controlling power switches of an inverter circuit 46 of the power output stage 2.

FIG. 1 also shows that the elevator electronic unit 1 has a plurality of electronic call interfaces 6 via which the central processor 4 can communicate digitally with external transmitters 27. In this way, the central processor 4 can, for example, receive external calls from the elevator shaft or from a display or from an operating interface of the elevator 22. However, as illustrated, the central processor 4 can also access an external network node 29 in this way, for example, which in turn can comprise its own CPU.

The central processor 4 also controls a door drive of the elevator car 20. In this case, the central processor 4 detects when the elevator car 20 enters a door zone by communicating with zone magnets arranged in the elevator shaft. In this case, the central processor 4 bridges an element in the safety chain of the elevator system. By controlling the safety chain, the central processor 4 enables the doors to be opened early (by activating the door drive) even before the car has reached a safe final stopping position within the door zone.

Characteristic of the architecture of the elevator electronic unit 1 according to the invention presented in FIG. 1 is thus that the central processor 4 controls the power output stage 2 as part of the motor control 37 in order to control and regulate the elevator motor 3 via this and thus specify the elevator operation, and that the central processor 4 also performs basic functions of the elevator operation, namely responding to external calls, specifying a travel curve for the elevator operation and evaluating the aforementioned safety circuit 23. As part of the motor control 37, the central processor 4 implements time-critical operations that must be executed in less than 1 ms. At the same time, however, the central processor 4 also takes over the travel operation control of the elevator system 28, which also includes numerous non-time-critical operations that can be processed at a lower speed. This is possible because the central processor 4 has a system of intelligent interrupts, so that time-critical and non-time-critical operations are processed sequentially one after the other by the central processor 4 in order of priority.

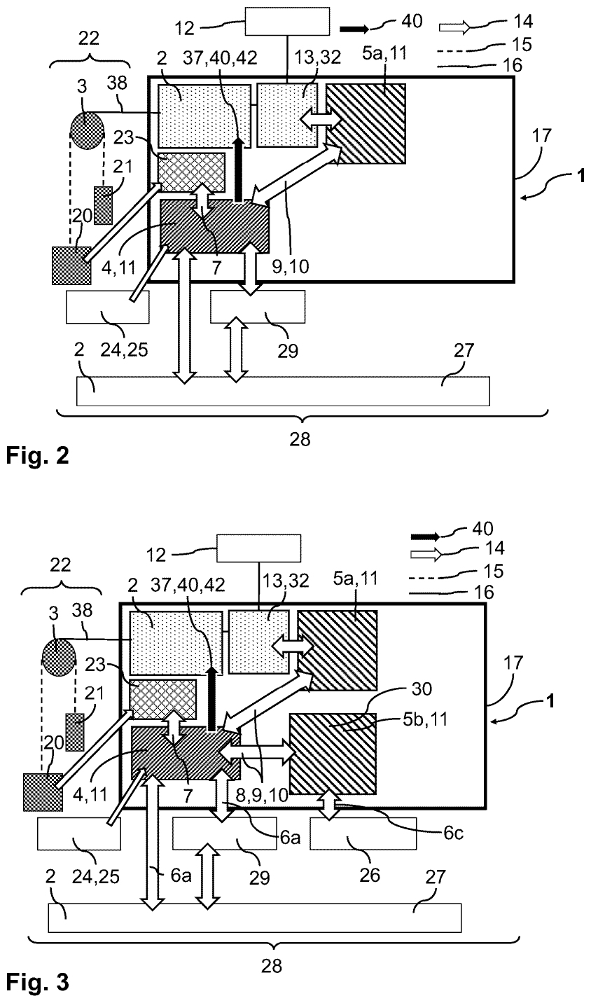

FIG. 2 shows a further possible design of an elevator electronic unit 1 according to the invention, which now, in comparison to FIG. 1, comprises an additional processor 5a. This additional processor 5a performs an additional function and thus supplements the functional scope of the central processor 4 in a modular manner, because the additional function can simply be added or omitted by adding/leaving out the additional processor.

In the example shown in FIG. 2, the central processor 4 communicates via the additional processor 5a with a feed-in and feedback unit 13, via which the power output stage 2 can draw power from the power supply system 12 or feed it back into the same. Such a regenerative feedback can take place, for example, if the elevator motor 3 is operated in regenerative mode and is used to brake the elevator car 20, in which case the resulting kinetic braking energy is converted into electrical power, which flows back into the power grid 12 via the unit 13. The central processor 4 thus implements an electrodynamic braking function or an energy recuperation function with the aid of the additional processor 5a.

In the example of FIG. 3, the elevator electronic unit 1, which is otherwise designed analogously to that of FIG. 2 or FIG. 1, comprises a further additional processor 5b, wherein here the central processor 4 communicates with the two additional processors 5a and 5b via respective internal communication interfaces 8, which are implemented by means of a BUS system 10. As can be seen in FIG. 3, an additional electronic call interface 6c is created by means of the additional processor 5b, via which the central processor 4, mediated by the additional processor 5b, can communicate with further peripheral devices 26. The additional processor 5b is operated by means of hardware-independent software, namely a Linux operating system.

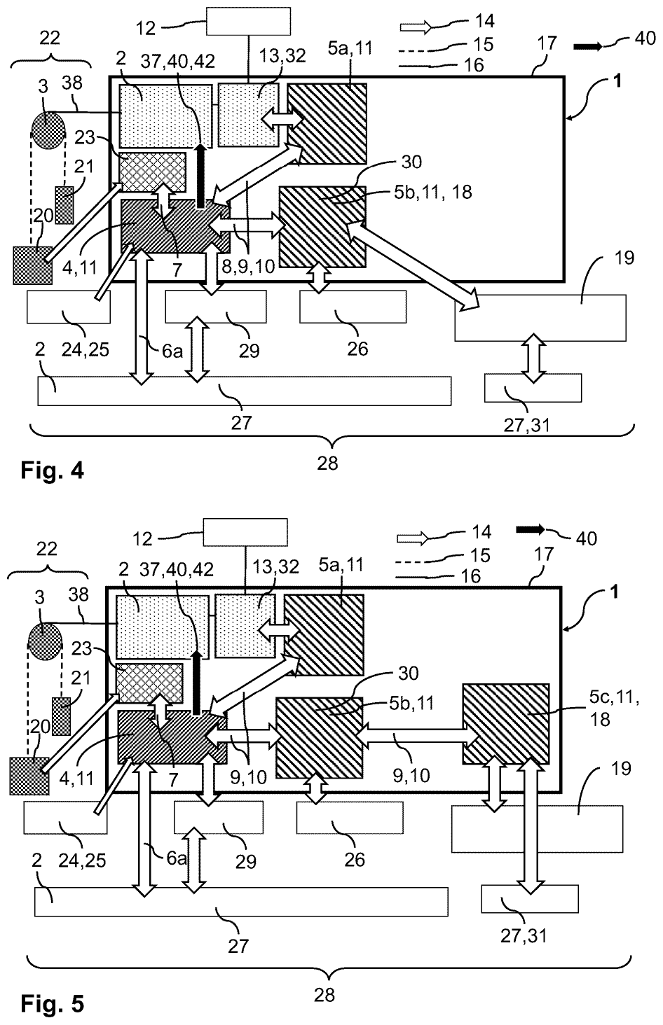

In the example shown in FIG. 4, the second additional processor 5b also assumes the function of a router 18 and thus mediates between the central processor 4 and an external instance 19 such as the Internet or a cloud.

In the further example of FIG. 5, on the other hand, a third additional processor 5c is provided, which here assumes the function of such a router 18, wherein this approach can also be used, for example, to receive calls from a remote control 31 or other (e.g. distant) external transmitters 27. With the aid of the BUS system 10, the central processor 4 can again access these external information sources 19, 27, 31 via the additional processor 5c or receive calls from them and convert them into corresponding operations. With this architecture, for example, an evacuation drive of the elevator 22 can be initiated via a remote control 31 without the central processor 4 having to have a direct connection to the Internet. To make this secure, authentication queries and the like can be implemented, for example.

Since the central processor 4 can communicate, in particular digitally, with numerous components of the elevator system 28, it can also collect and document operating parameters during operation of the elevator system 28. This includes, in particular, the documentation of error messages and the actual travel curves completed by the elevator car 20. The central processor 4 also autonomously carries out safe test drives at night without passengers in the elevator car 20 and measures the current consumption of the drive unit and other operating parameters. From such collected operating parameters, the central processor 4 then determines estimated values for the remaining service life of individual components. If such a remaining service life is too short, the central processor 4 (with the help of the additional processor 5c) can send a push message via the Internet and thus initiate maintenance of the elevator system 28. The push message can include information on which component needs to be replaced/maintained. If, for example during a night-time test drive, a significant deviation in the current consumption or an impermissible step response of the drive unit is detected by the central processor 4, it can also autonomously adjust the motor control 37 and thus autonomously optimize the operation of the elevator system 38.

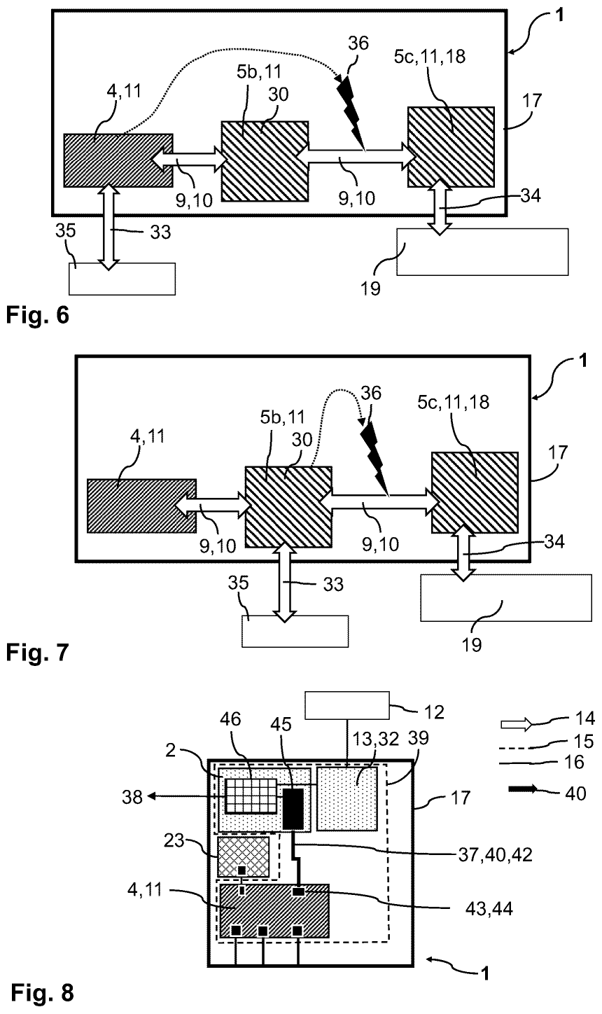

FIG. 6 illustrates a method according to the invention, with which the central processor 4 can release a peripheral software update, which is to be installed on one of the additional processors 5 of the elevator electronic unit 1 shown. Such a software update can, for example, be retrieved via the additional processor 5c from an external instance 19 such as a secure server. In accordance with the invention, it is now provided that-even before the peripheral software update is installed on the respective additional processor 5—the permissibility and security of this update is first checked by the central processor 4. For this purpose, the central processor 4 checks a release condition. For example, a 2-factor authentication can be provided as a release condition, in which the central processor 4 accesses the external server 19 via the additional processor 5c and also requests a confirmation by means of an operator query 33, which a service technician must enter manually using the input device 35 shown. The central processor 4 can therefore first check the permissibility of the update using the external server 19 via a security query 34 and also use the operator query 33 to ensure that the software update can actually be carried out as desired and safely at this time because it has been approved by the service technician.

FIG. 7, on the other hand, shows the case where a central software update is to be installed on the central processor 4. This software update can also be obtained, for example, via the router 18 from an external instance 19 or, for example, in a manner known per se, from an electronic storage device such as a USB stick, which is plugged into a corresponding interface of the elevator electronic unit 1. In this case too, the central software update is only uploaded to the central processor 4 after it has been released, but this release is carried out by one of the additional processors 5 of the elevator electronic unit 1. The responsible additional processor 5 checks at least one release condition for this purpose, wherein it can be particularly advantageous if this release condition relates to parameters, for example a number of error-free trips of the elevator system 28, which were already recorded and stored during the operation of the elevator system 28 before the software update was installed. In order to prevent safety-relevant functions of the elevator system 28 from being impaired by the installation of the central software update, the additional processor 5 only releases the central software update if a 2-factor authentication has been successfully performed. One of the two factors of this authentication cannot be entered remotely, but must be entered on site by a service technician by manually actuating an operating element of the elevator electronic unit 1.

FIG. 1, which roughly represents a minimum solution of an elevator unit 1 according to the invention, also makes it easy to understand how this system can be used to carry out a downstream security check, which is only carried out after a central software update has been installed on the central processor 4: For this purpose, it can be provided that the said upload first triggers the security check. The central processor 4 can then, for example at regular intervals and/or in particular at night, carry out safe test drives with the elevator 22 without people in the elevator car 20 and collect (i.e. record and store) operating parameters which can be recorded by sensors, for example via connected field devices 24. If a sufficient number of such safe test drives have been carried out, the central processor 4 can then carry out the security check using these collected operating parameters/data and thus decide whether the operating parameters document correct functioning of the elevator system 28 and thus whether safe operation of the elevator 22 can be guaranteed even after the central software update has been installed. If, on the other hand, the security check is negative, the central processor 4 blocks further operation of the elevator 22, at least as soon as there are people in the elevator car 20.

In summary, an intelligent elevator electronic unit 1 is proposed having a central processor 4 which both implements a motor control 37 comprising time-critical motor control commands and performs basic functions of elevator operation, such as responding to external calls, specifying a travel curve or evaluating a safety circuit 23 of the elevator system 28 in which the elevator electronic unit 1 is used to control an elevator motor 3. The elevator electronic unit 1 also comprises the power output stage 2 required for operating the elevator motor 3 and can also comprise one or more additional processors 5, with which the functionality of the elevator electronic unit 1 can be expanded in a modular fashion. With this architecture, it is possible in particular to safely carry out software updates of the central processor 4 and/or an additional processor 5, to carry out a downstream security check of such a software update or, for example, to autonomously optimize the operation of the elevator system 28 with the aid of the central processor 4.

### LIST OF REFERENCE SIGNS

1 Elevator electronic unit/elevator control device
2 Power output stage (generates 38 for operation of 3; part of 39)
3 Elevator motor
4 Central processor (controls 3 indirectly and 2 directly)
5 Additional processor (communicates with 4; can optionally establish a connection between an external network, e.g. the Internet, and 4).
6 Electronic call interface
7 Electronic safety interface
8 Electronic internal communication interface
9 Serial interface
10 BUS system
11 Processor (in particular designed as a microprocessor or microcomputer)
12 Power grid
13 Feed-in and feedback unit (for drawing power from 12 or feeding power back into 12)
14 Signal path (especially as part of 10)
15 Support means (e.g. steel cables)
16 Electrical connection (especially bidirectional)
17 Housing
18 Router
19 External instance (Internet/cloud/server)
20 Elevator car
21 Counterweight
22 Elevator
23 Safety circuit (especially implemented as a hardware circuit)
24 Field device (e.g. shaft position sensor)
25 Sensor/actuator
26 Peripheral device (not safety-critical)
27 External transmitter (e.g. elevator user, external calls, from the shaft box/inspection box, from a display or from an operating interface)
28 Elevator system
29 Network node (optionally with its own processor/CPU)
30 Hardware-independent software
31 Remote control (from 22/28 mediated by 1)
32 Input stage (AC/DC converter, provides DC voltage for 2)
33 Operator query (=1st factor)
34 Security query (=2nd factor)
35 Input device (control button, smart phone with app, etc.)
36 Security check
37 Motor control
38 AC output voltage (generated by 2 on the basis of 40/42)
39 Frequency converter
40 Analog signal or PWM signal
41 Error message
42 Motor control signal
43 Analog signal output
44 PWM unit
45 Hardware circuit (in particular comprising a low-pass filter for filtering a PWM signal)
46 Inverter circuit (with power transistors)
47 Drive unit

1. An elevator electronic unit (1) for controlling elevator operation of an elevator system (28), the elevator electronic unit comprising:
a power output stage (2) for supplying an elevator motor (3) of the elevator system (28) with an AC output voltage (38);
a processor (11) which is a central processor (4) and is configured to
directly control the power output stage (2) via motor control signals (42) as part of a motor control system (37) in order to control and regulate the elevator motor (3) via the power output stage (2), and
perform basic functions of elevator operation, including responding to external calls from external transmitters (27, 31) by generating and outputting the corresponding motor control signals (42) based on a respective travel curve for elevator operation, in order to travel to a specific elevator stop with an elevator car (20) of the elevator system (28).

2. The elevator electronic unit (1) according to claim 1, wherein the central processor (4) is further configured to predetermine the respective travel curve, taking into account a received external call and evaluation of at least one piece of information relating to a current position of the elevator car (20) of the elevator system (28), and the at least one piece of information is queried by the central processor (4) via at least one of a) a sensor, b) based on a virtual image of the elevator system (38), or c) based on an evaluation of a safety circuit (23).

3. The elevator electronic unit (1) according to claim 1, wherein at least one of a) the central processor (4), together with the power output stage (2), implements a frequency converter (39), or b) the central processor (4) comprises at least one of an analog signal output (43) or at least one PWM unit (44), which is directly connected to the power output stage (2).

4. The elevator electronic unit (1) according to claim 1, wherein the central processor (4) is further configured to implement at least one of
the motor control (37) of the elevator motor (3), which comprises time-critical operations that must be executed in less than 1 ms,
and
a travel operation control of the elevator system (28) comprising less time-critical operations, which can be executed in more than 1 ms, or non-time-critical operations, which must be executed within 10 ms.

5. The elevator electronic unit (1) according to claim 4, wherein at least one of a) the central processor (4) is further configured to process the engine control (37) with priority of the time-critical operations over the travel operation control, including the non-time-critical operations, or b) the central processor (4) is configured for, when executing the motor control (37), processing at least one of time-critical or real-time relevant signals and/or generating at least one of time-critical or real-time relevant motor control signals (42).

6. The elevator electronic unit (1) according to claim 1, wherein the elevator electronic unit (1) comprises at least one additional processor (5) which is configured to perform at least one additional function which modularly supplements a functional scope of the central processor (4), and the at least one additional processor (5) at least one of a) is plugged into a mainboard on which the central processor (4) is implemented, b) adapted to communicate with the central processor (4) by a serial interface (9), or c) communicate with the central processor (4) via a dual-ported RAM.

7. The elevator electronic unit (1) according to claim 6, wherein the at least one additional processor (5) is at least one of operated, operable, or comprises software with a standardized hardware-independent programmable software (30).

8. The elevator electronic unit (1) according to claim 6, wherein the at least one additional processor (5) communicates with the central processor (4) based on interrupts, in which the at least one additional processor (5) is set up to trigger a central interrupt of the central processor (4) in order to trigger a central interrupt service routine of the central processor assigned to this central interrupt and/or the central processor (4) is set up to trigger a peripheral interrupt of the at least one additional processor (5) in order to trigger a peripheral interrupt service routine of the at least one additional processor (5) assigned to this peripheral interrupt.

9. The elevator electronic unit (1) according to claim 6, wherein the at least one additional processor (5) is adapted to transmit information to the central processor (4), but is not adapted to access the central processor (4) in a controlling manner.

10. The elevator electronic unit (1) according to claim 9, wherein the central processor (4) is configured to access the at least one additional processor (5) in a controlling manner, in order to adapt a sequence of an instruction execution of the at least one additional processor (4) and/or in order to put the at least one additional processor (4) into a sleep mode or idle state or to wake the at least one additional processor (4) up from such a state.

11. The elevator electronic unit (1) according to claim 1, wherein the central processor (4) configured for at least one of:
a) effecting door control,
b) monitoring an instantaneous state of a safety chain of the elevator system (28), or
c) acting in a controlled manner on the safety chain of the elevator system (28) as a function of at least one received sensor signal.

12. The elevator electronic unit (1) according to claim 6, further comprising at least one of:
an electronic call interface (6), via which the central processor (4) is adapted receive and evaluate the external calls,
at least one electronic safety interface (7), via which the central processor (4) is adapted receive and evaluate signals from the at least one safety circuit (23) and/or have a controlling effect on the safety circuit (23),
at least one electronic internal communication interface (8), via which the central processor (4) is adapted to communicate with the at least one additional processor (5).

13. The elevator electronic unit (1) according to claim 1, wherein the central processor (4) is configured for collecting operating parameters, including at least one of:
a) current consumption of components of the elevator system (28),
b) temperature curves,
c) error messages,
d) travel curves actually traveled, or
e) sensor data,
during operation of the elevator system (28), by autonomously performed safe test drives without passengers, and documenting the same for the purpose of determining based on collected operating parameters at least one of
a) at least one wear parameter,
b) an estimate of a remaining service life of at least one component of the elevator system (28), such that determinations/estimates to initiate maintenance of the elevator system (28) and/or replacement of a component of the elevator system (28), are made, or
c) autonomously optimizing the travel operation of the elevator system (28).

14. The elevator electronic unit (1) according to claim 6, wherein the central processor (4) is further configured to perform a security check of a peripheral software update which is to be obtained from an external source, and is to be installed on the at least one additional processor (5), and the peripheral software update is only be installable on the additional processor (5) after it has been released by the central processor (4).

15. The elevator electronic unit (1) according to claim 6, wherein the at least one additional processor (5) comprises a further additional processor (5) which is set up to perform a security check of a central software update which is to be obtained from an external source and is to be installed on the central processor (4), in order to update and/or adapt a function of the central processor (4) which is relevant to safety for the travel operation of the elevator system, and the central software update is only installable on the central processor (4), based on a secure 2-factor authentication, after it has been released by the additional processor (5).

16. The elevator electronic unit (1) according to claim 6, wherein at least one of
a) the at least one additional processor (5) or the central processor (4) is configured to perform a downstream security check after a central software update has been installed on the central processor (4), and blocks travel of the elevator system with persons as soon as the downstream security check reveals faulty operation or an error in the central software update, or
b) the power output stage (2) comprises part of an active front-end (AFE) converter (39), and the central processor (4) is configured to control the AFE converter (39) such that, when the elevator motor (3) is operating in a regenerative mode, kinetic braking power is adapted to be fed back electrically into an external network (12) using the AFE converter (39).

17. An elevator system (28), comprising:
an elevator car (20),
associated support (15),
a drive unit (47) with elevator motor (3) and
an elevator electronic unit (1) according to claim 1, with which the elevator motor (3) is or is adapted to be controlled.

18. A method for securely updating an elevator electronic unit (1), the method comprising:
uploading a central software update to a processor (11) of the electronic unit (1), and
checking security of the central software update by an additional processor (5), before the central software update is installed, and the additional processor (5) releasing the central software update depending on a result of the check,
wherein the additional processor (5) checks at least one release condition for prior to releasing the central software update.

19. The method according to claim 18, wherein at least one of a) the release condition relates to parameters which were recorded and stored during operation of the elevator system before the central software update was installed, or b) the checking of the central software update includes authentication.

20. A method for a downstream autonomous security check of an elevator electronic unit (1), the method comprising:
triggering the security check by uploading a central software update to a processor (11) of an elevator electronic unit (1) of an elevator system,
checking an admissibility of software used by the processor (11) for operation thereof at regular intervals, and
carrying out safe test drives without passengers with the elevator system for the security check and recording operating parameters that are taken into account in the downstream security check.
